(19) United States
(12) Patent Application Publication
(10) Pub. No.: US 2024/0078923 A1
(43) Pub. Date: Mar. 7, 2024

(54) TEST FAMILIAR DETERMINATION DEVICE, TEST FAMILIAR DETERMINATION METHOD AND STORAGE MEDIUM

(71) Applicant: NEC Corporation, Tokyo (JP)

(72) Inventors: Terumi UMEMATSU, Tokyo (JP); Masanori TSUJIKAWA, Tokyo (JP)

(73) Assignee: NEC Corporation, Tokyo (JP)

(21) Appl. No.: 18/504,566

(22) Filed: Nov. 8, 2023

Related U.S. Application Data
(63) Continuation of application No. 18/205,442, filed on Jun. 2, 2023.

(30) Foreign Application Priority Data
Jun. 14, 2022 (JP) 2022-095808

(51) Int. Cl. G09B 5/00; G06N 5/04

(52) U.S. Cl. CPC G09B 5/00; G06N 5/04

(57) ABSTRACT

The determination device 1x mainly includes an attribute data acquisition means 15X, a trial quantity estimation means 16X, and a familiarity determination means 17X. The attribute data acquisition means 15X is configured to acquire attribute data indicating an attribute of a subject. The trial quantity estimation means 16X is configured to estimate a required trial quantity, which is a trial quantity to be required for the subject to become familiar with a test undergone by the subject, based on the attribute data. The familiarity determination means 17X is configured to determine whether or not the subject is familiar with the test, based on the required trial quantity.

### INCORPORATION BY REFERENCE

This application is a Continuation of U.S. application Ser. No. 18/205,442, filed on Jun. 2, 2023, which is based upon and claims the benefit of priority from Japanese Patent Application No. 2022-95808, filed on Jun. 14, 2022, the disclosure of which is incorporated herein in its entirety by reference.

### TECHNICAL FIELD

The present disclosure relates to the technical field of a determination device, a determination method, and a storage medium for performing a determination process relating to a test such as a cognitive function test.

### BACKGROUND ART

There is known a device or system that performs processing on a test to measure the cognitive function of a subject. For example, Patent Literature 1 discloses an information management system which includes a test unit configured to conduct a test of a user related to cognitive ability and a determination unit configured to determine a result of the test. Patent Literature 2 discloses a cognitive function estimation device configured to estimate a cognitive function level of a subject based on a variation in the estimation result of the emotion level during a predetermined time period.

### CITATION LIST

### Patent Literature

Patent Literature 1: JP 2021-135829A
Patent Literature 2: JP 2021-058231A

### SUMMARY

Generally, for a test such as a cognitive function test, a test result fluctuates depending on whether or not the subject is familiar with the test. Therefore, when the test result when the subject is not familiar with the test is used, the current state of the subject could not be accurately grasped.

In view of the above-described issues, one object of the present disclosure is to provide a determination device, a determination method, and a storage medium capable of accurately making a determination relating to a test.

In an example aspect of the present disclosure, there is provided a determination device including:
an attribute data acquisition means configured to acquire attribute data indicating an attribute of a subject;
a trial quantity estimation means configured to estimate a required trial quantity, which is a trial quantity to be required for the subject to become familiar with a test undergone by the subject, based on the attribute data; and
a familiarity determination means configured to determine whether or not the subject is familiar with the test, based on the required trial quantity.

In an example aspect of the present disclosure, there is provided a determination method executed by a computer, the determination method including:
is acquiring attribute data indicating an attribute of a subject;
estimating a required trial quantity, which is a trial quantity to be required for the subject to become familiar with a test undergone by the subject, based on the attribute data; and
determining whether or not the subject is familiar with the test, based on the required trial quantity.

In an example aspect of the present disclosure, there is provided a storage medium storing a program executed by a computer, the program causing the computer to:
acquire attribute data indicating an attribute of a subject;
estimate a required trial quantity, which is a trial quantity to be required for the subject to become familiar with a test undergone by the subject, based on the attribute data; and
determine whether or not the subject is familiar with the test, based on the required trial quantity.

An example advantage according to the present disclosure is to accurately make a determination relating to a test.

### BRIEF DESCRIPTION OF THE DRAWINGS

FIG. 1 illustrates a schematic configuration of a test determination system according to a first example embodiment.

FIG. 2 illustrates a hardware configuration of an information processing device.

FIG. 3 illustrates an example of a functional block of the information processing device.

FIG. 4 illustrates an example of a detailed block diagram of a trial quantity estimation unit.

FIG. 5 illustrates an example of a test result screen image.

FIG. 6 illustrates experimental results indicative of respective average correct answer rates of subjects in their 20's to 50's and subjects in their 60's to 80's for a certain test.

FIG. 7 illustrates an example of a functional block relating to learning of a trial quantity inference model.

FIG. 8 illustrates an example of a detailed functional block of a training unit.

FIG. 9 illustrates an example of a flowchart showing a processing procedure of the information processing device when a test for a subject is conducted.

FIG. 10 illustrates a schematic configuration of a test determination system in a second example embodiment.

FIG. 11 illustrates a block diagram of a determination device according to a third example embodiment.

FIG. 12 illustrates an example of a flowchart to be executed by the determination device in the third example embodiment.

### EXAMPLE EMBODIMENTS

Hereinafter, an example embodiment of a determination device, a determination method,

and a storage medium will be described with reference to the drawings.

### First Example Embodiment

(1) System Configuration

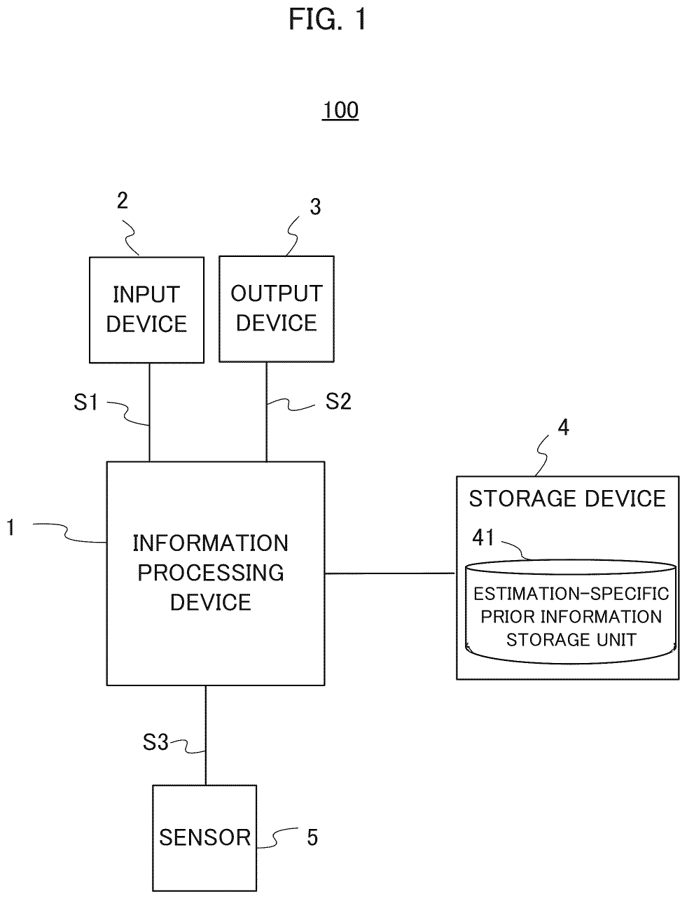

FIG. 1 shows a schematic configuration of a test determination system 100 according to the first example embodiment. When a subject (examinee) has undergone a test, the test determination system 100 determines whether or not the subject is familiar with the test and outputs information indicating the validity of the test result.

Here, the term “test” herein indicates a test conducted to measure a predetermined function, ability, skill, or the like of a subject, and the result thereof is affected by the subject's familiarity with the test. For example, the test described above may be a test of cognitive function(s) relating to at least one of categories of intelligence (e.g., language understanding, perceptual integration, working memory, processing speed), an attention function, a frontal leaf function, language, memory, visual space cognition, and directed attention. Further, in the present example embodiment, the test shall be collectively conducted for multiple times as necessary until an accurate test result is obtained. Further, hereafter, the term “examination” shall refer to a set of test trials until an accurate test result is obtained.

The test determination system 100 mainly includes an information processing device 1, an input device 2, an output device 3, and a storage device 4. The information processing device 1 performs data communication with the input device 2 and the output device 3 via a communication network or by wireless or wired direct communication.

The information processing device 1 generates test result information which is information regarding the test result of a test undergone by a subject, based on the input signal “S1” supplied from the input device 2 and information stored in the storage device 4. The information processing device 1 generates an output signal “S2” regarding the test result information and supplies the generated output signal S2 to the output device 3. In generating the test result information, the information processing device 1 calculates, based on the attribute of the subject, a trial quantity (also referred to as “required trial quantity”) of the test to be required for the subject to become familiar with the test, considering that the trial quantity of the test to be required to obtain an accurate test result varies depending on the attribute(s) of the subject who undergoes the test. Then, the information processing device 1 determines, based on the calculated required trial quantity, whether or not the subject is familiar with the test, and determines the validity of the test result based on whether or not the subject is familiar with the test, respectively, and generates test result information indicating the test result and the determination result of the validity of the test result.

Here, the term “trial quantity” refers to the trial quantity in one examination, and it may be the number of times (i.e., number of trials) the subject has undergone the test in the one examination, or the length of duration for which the subject is undergoing the test in the one examination. In such a case that a plurality of inspections are conducted at short time intervals, the “trial quantity” may refer to total trial quantity of the plurality of examinations conducted at the short time intervals. This example will be described in the section “(6) Modifications”.

The information processing device 1 may also perform processing relating to learning of a model (also referred to as “trial quantity inference model”) configured to infer a required trial quantity to be described later.

The input device 2 is one or more user interfaces configured to receive input (external input) of information regarding a subject, and supplies the generated input signal S1 to the information processing device 1. In the present example embodiment, for example, the input device 2 is used by a subject to input a test answer or the like when the subject undergoes a test. Examples of the input device 2 include a touch panel, a button, a keyboard, a mouse, a voice input device, and any other variety of user input interfaces.

The input device 2 may include one or more sensors configured to generate a biological signal (including vital information) necessary for generating a result of the test undergone by the subject. In this case, examples of the input device 2 include a wearable terminal worn by the subject, a camera for photographing the subject or a microphone for generating a voice signal of utterance of the subject, and a terminal such as a personal computer or a smartphone operated by the subject.

The output device 3 displays or outputs by audio the test result information or the like to the user based on the output signal S2 supplied from the information processing device 1. Here, the term “user” herein may indicate the subject itself, or may indicate a person (e.g., doctor, caretaker, supervisor, etc.) who manages or supervises the activity of the subject. Examples of the output device 3 include a display, a projector, a speaker, and the like.

The storage device 4 is one or more memories which store various information necessary for processing performed by the information processing device 1. The storage device 4 may be an external storage device, such as a hard disk, connected to or embedded in the information processing device 1, or may be a storage medium, such as a flash memory. The storage device 4 may be one or more server devices that performs data communication with the information processing device 1. Further, the storage device 4 may be configured by a plurality of devices.

The storage device 4 functionally includes an estimation-specific prior information storage unit 41. The estimation-specific prior information storage unit 41 stores estimation-specific prior information, which is information to be used for estimating the required trial quantity of the subject, and which is information prepared in advance before the execution of the test.

Here, a first example of the estimation-specific prior information is parameters of a model (also referred to as “trial quantity inference model”) which learned the relation between data based on attribute data indicating one or more attributes of a subject and the required trial quantity. The trial quantity inference model is, in other words, a model that learned to output an inference result indicating an appropriate required trial quantity according to the attributes of the subject when attribute data indicating the attributes of the subject or feature data (feature vector) representing the features thereof is inputted to the model. The trial quantity inference model is, for example, any machine learning model (including a statistical model, the same applies hereinafter) such as a neural network and a support vector machine. For example, when the trial quantity inference model described above is a model based on a neural network such as a convolution neural network, the estimation-specific prior information storage unit 41 stores information indicative of various parameters such as a layer structure, a neuron structure of each layer, the number of filters and the filter size in each layer, and the weight for each element of each filter as the estimation-specific prior information.

As will be described later, the trial quantity inference model may be a model configured to infer the required trial quantity based on data based on attribute data of the subject and the test results undergone by the subject in the past. When there is a possibility that plural types of tests (i.e., plural tests having different protocols) may be conducted in the test determination system 100A, the learned parameters of the trial quantity inference model for each type of test are stored in the estimation-specific prior information storage unit 41.

A second example of estimation-specific prior information is a table (also referred to as a “trial quantity determination table”) in which each candidate for the attribute(s) of a subject is associated with an appropriate required trial quantity corresponding to the each candidate. The trial quantity determination table is generated in advance based on the test results or the like of the subjects who underwent the test in the past.

When there is a possibility that plural types of tests may be conducted, the trial quantity determination table for each type of test is stored in the estimation-specific prior information storage unit 41. In this case, if there are similar types of tests, a common trial quantity determination table may be used for the similar types of tests. For example, for a certain test whose results in the past are not sufficient to generate the trial quantity determination table, a trial quantity determination table that was generated based on the test results of the test similar to the certain test. The presence or absence of the similarity may be determined, for example, by whether or not the tests of interest fall under a common category. The presence or absence of similarity may be determined further based on the commonality in the difficulty of the tests of interest in addition to the above-described commonality of the categories.

In addition, in such a case that the information processing device 1 trains the trial quantity inference model, training data necessary for training the trial quantity inference model is further stored in the storage device 4. This training data will be described later.

The configuration of the test determination system 100 shown in FIG. 1 is an example, and various changes may be made to the configuration. For example, the input device 2 and the output device 3 may be integrally configured. In this case, the input device 2 and the output device 3 may be configured as a tablet type terminal that is integrated with or separated from the information processing device 1. Further, the information processing device 1 may be configured by a plurality of devices. In this case, the plurality of devices functioning the information processing device 1 performs transmission and reception of information necessary for executing pre-assigned processing among the plurality of devices. In this case, the information processing device 1 functions as a system.

(2) Hardware Configuration

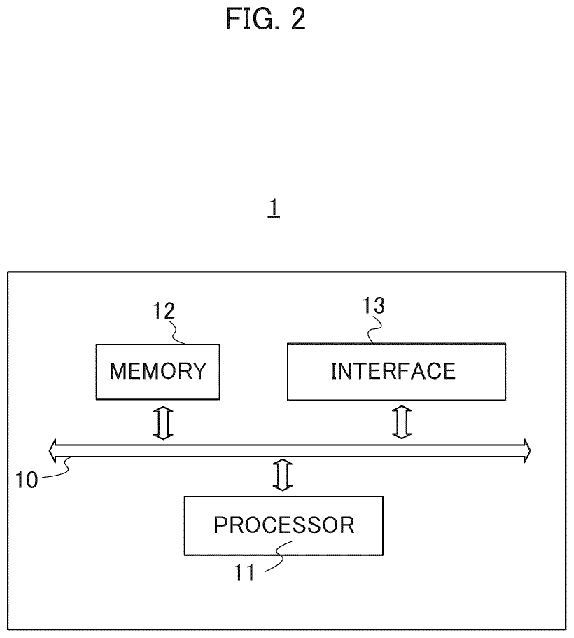

FIG. 2 shows a hardware configuration of the information processing device 1. The information processing device 1 includes a processor 11, a memory 12, and an interface 13 as hardware. The processor 11, memory 12 and interface 13 are connected to one another via a data bus 10.

The processor 11 functions as a controller (arithmetic unit) configured to control the entire information processing unit 1 by executing a program stored in the memory 12. Examples of the processor 11 include a CPU (Central Processing Unit), a GPU (Graphics Processing Unit), a TPU (Tensor Processing Unit) and the like. The processor 11 may be configured by a plurality of processors. The processor 11 is an example of a computer.

The memory 12 is configured by a variety of volatile and non-volatile memories, such as a RAM (Random Access Memory), a ROM (Read Only Memory), and a flash memory. Further, a program for executing a process executed by the information processing device 1 is stored in the memory 12. A part of the information stored in the memory 12 may be stored by one or more external storage devices that can communicate with the information processing device 1, or may be stored in a storage medium detachable to the information processing device 1.

The interface 13 is one or more interfaces for electrically connecting the information processing device 1 to other devices. Examples of the interfaces include a wireless interface, such as network adapters, for transmitting and receiving data to and from other devices wirelessly, and a hardware interface, such as a cable, for connecting to other devices.

The hardware configuration of the information processing device 1 is not limited to the configuration shown in FIG. 2. For example, the information processing device 1 may include at least one of the input device 2 and the output device 3. Further, the information processing device 1 may be connected to or incorporate a sound output device such as a speaker.

(3) Functional Block

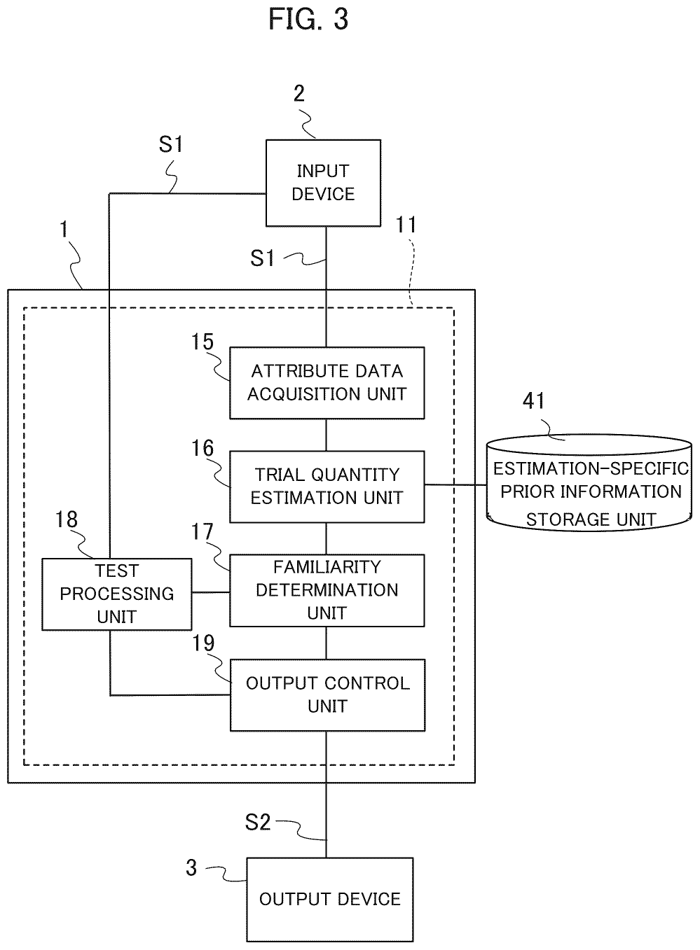

FIG. 3 is an example of a functional block diagram of the information processing device 1. The processor 11 of the information processing device 1 functionally includes an attribute data acquisition unit 15, a trial quantity estimation unit 16, a familiarity determination unit 17, a test processing unit 18, and an output control unit 19. In FIG. 3, blocks to exchange data with each other are connected by solid line, but the combinations of the blocks to exchange data with each other is not limited thereto. The same applies to the drawings of other functional blocks described below.

The attribute data acquisition unit 15 acquires the attribute data of the subject through the interface 13. In this instance, for example, the attribute data acquisition unit 15 acquires the attribute data of the subject based on the input signal S1 supplied from the input device 2. The attribute data acquisition unit 15 may acquire the attribute data of the subject by reading the attribute data of the subject stored in the storage device 4. In this case, for example, the attribute data associated with the identification information of the subject is stored in advance in the storage device 4.

Here, the attribute data is information indicating one or more attributes of the subject, and it may be information indicating an inherent attribute (i.e., an attribute dependent on the living body), or may be information indicating an acquired attribute (i.e., an attribute dependent on the environment). Examples of attributes in this case include age, diagnostic results (including past medical history), health checkup results (e.g., regarding visual acuity, hearing acuity, life-habit sickness, etc.,), gender, race, genetic information, academic history, capability index such as intelligence quotient (IQ) and aptitude test results, occupation, personality measured based on Big Five Personality Test, lifestyle, and lifestyle habits (e.g., presence or absence of smoking habits, presence or absence of drinking habits, exercise habits, eating habits, social activities, communication). The attributes of the subject may be any one or more attributes that fall under the inherent attributes or the acquired attributes.

The trial quantity estimation unit 16 estimates the required trial quantity based on the attribute data acquired by the attribute data acquisition unit 15 and the estimation-specific prior information stored in the estimation-specific prior information storage unit 41. In this case, in the first example, when the estimation-specific prior information indicates learned parameters of the trial quantity inference model, the trial quantity estimation unit 16 inputs the attribute data or the feature data representing the features of the attribute data to the trial quantity inference model configured by referring to the learned parameters, and acquires the required trial quantity outputted by the trial quantity inference model in response to the input. In the second example, when the estimation-specific prior information is the trial quantity determination table, the trial quantity estimation unit 16 acquires, as an estimate of the required trial quantity, the required trial quantity linked in the trial quantity determination table to the attributes indicated by the attribute data acquired by the attribute data acquisition unit 15.

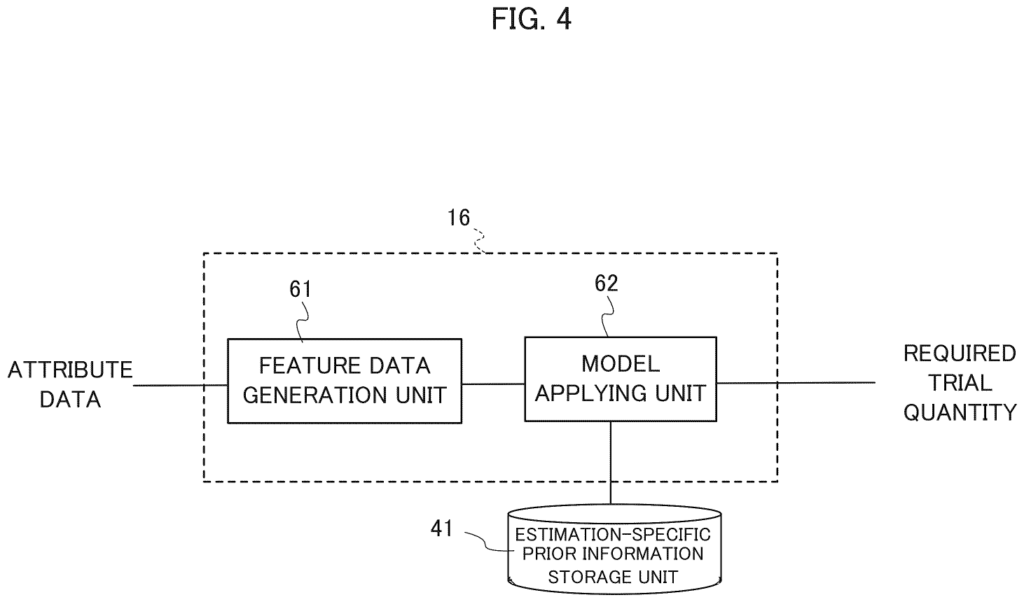

FIG. 4 is an example of a detailed block diagram of the trial quantity estimation unit 16 in the first example described above. The trial quantity estimation unit 16 includes, for example, a feature data generation unit 61 and a model applying unit 62.

The feature data generation unit 61 generates feature data representing the features of the attribute data acquired by the attribute data acquisition unit 15. The feature data is data in a predetermined tensor format that is an input format of the trial quantity inference model to be used by the model applying unit 62. The feature extraction process executed by the feature data generation unit 61 may be a process based on any feature extraction technique. The model applying unit 62 inputs the feature data supplied from the feature data generation unit 61 to the trial quantity inference model configured by referring to the estimation-specific prior information storage unit 41 and acquires the required trial quantity outputted by the trial quantity inference model in response to the input. Then, the model applying unit 62 supplies the acquired required trial quantity to the familiarity determination unit 17.

By referring again to FIG. 3, the functional blocks of the information processing device 1 will be described.

The familiarity determination unit 17 determines whether or not the subject is familiar with (accustomed to) the test based on the required trial quantity estimated by the trial quantity estimation unit 16 and the history information regarding the tests undergone by the subject, which is supplied from the test processing unit 18 to be described later. Here, the history information includes a value (also referred to as “actual trial quantity”) representing the actual trial quantity of the test undergone by the subject at the present time. The actual trial quantity is, for example, the number of times the subject has already undergone the test in the current examination or the length of time the subject has undergone the test in the current examination. For example, the familiarity determination unit 17 determines that the subject is familiar with the test, if the actual trial quantity is equal to or higher than the required trial quantity. In contrasts, the familiarity determination unit 17 determines that the subject is not familiar with the test if the actual trial quantity is less than the required trial quantity. Then, the familiarity determination unit 17 supplies the determination result (also referred to as “familiarity determination result”) as to whether or not the subject is familiar with the test to the output control unit 19.

When the test processing unit 18 receives data (referred to as “test determination data”) necessary for determination of the test (i.e., data for generating a test result), the test processing unit 18 generates a test result based on the test determination data to thereafter supply the generated test result to the output control unit 19. The test determination data is, for example, an input signal S1 supplied from the input device 2 to be operated by the subject during the test (or from the input device 2 to sense the subject). The test processing unit 18 generates history information including at least the actual trial quantity of the test that the subject has undergone, and supplies the generated history information to the familiarity determination unit 17. The test processing unit 18 may store, in the storage device 4, the generated test result and the history information in association with the identification information of the subject and the test, and the date-and-time information of the examination.

The output control unit 19 outputs information regarding the test result of the test that the subject has undergone. For example, the output control unit 19 displays the test result supplied from the test processing unit 18 on the display unit of the output device 3 or outputs the sound by the sound output unit of the output device 3. In this case, the output control unit 19 determines, based on the familiarity determination result supplied from the familiarity determination unit 17, the validity of the outputted test result, and displays or outputs by audio the information indicating the determination result of the validity by the output device 3. In the determination of the validity, for example, the output control unit 19 determines that the test result is valid if the familiarity determination result indicates the presence of familiarity, and determines that the test result is not valid if the familiarity determination result indicates the absence of the familiarity.

The output control unit 19 may output, together with the test result, the required trial quantity estimated by the trial quantity estimation unit 16 or the attribute data acquired by the attribute data acquisition unit 15 as the information used for the familiarity determination.

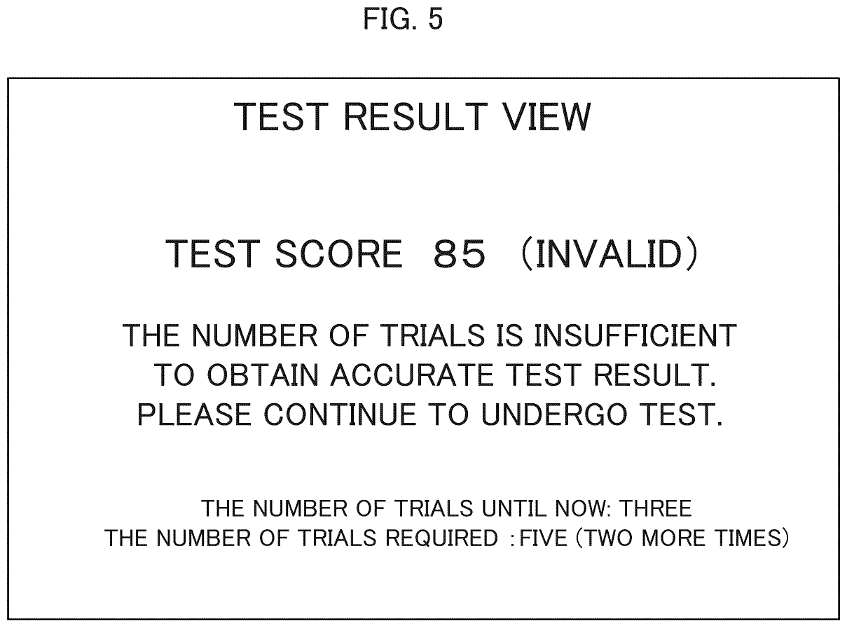

FIG. 5 is an example of a test result screen image to be displayed by the output control unit 19 on the output device 3. The output control unit 19 generates an output signal S2 and supplies the output signal S2 to the output device 3 to cause the output device 3 to display the test result screen image shown in FIG. 5.

Here, the output control unit 19 displays the information indicating that the test result is not valid (invalid) on the test result screen image on the basis of the familiarity determination result supplied from the familiarity determination unit 17 together with the test score (here, “85”) based on the test result supplied from the test processing unit 18. In addition, the output control unit 19 displays advice text stating that “the number of trials is insufficient to obtain accurate test result. Please continue to undergo test” based on the familiarity determination result, and also displays information (“the number of trials until now: three”) regarding the actual trial quantity used for generating the familiarity determination result and information (“the number of trials required: five (two more times)”) regarding the required trial quantity on the test result screen image. Instead of the example shown in FIG. 5, the output control unit 19 may hide the test result (test score in FIG. 5) if it is determined that the test result is not valid based on the familiarity determination result, whereas the output control unit 19 displays the test result if it is determined that the test result is valid.

Thus, the output control unit 19 can clearly inform, based on the familiarity determination result, the subject or the manager of the subject, which is the user, of the validity of the test result. Besides, output control unit 19 may output advice information for assisting the manager's decision-making regarding whether or not the subject should continue to undergo the test. It is noted that the above-mentioned advice text shown in FIG. 5 is a specific example of the above-mentioned advice information,

Instead of displaying or outputting by audio information regarding the test result based on the familiarity determination result by the output device 3, the output control unit 19 may store information regarding the test result based on the familiarity determination result in the storage device 4. In this case, for example, the output control unit 19 may store only the test result determined that the test result is valid in the storage device 4. For example, when collecting the training data of the inference model which infers the inner surface condition from input data including the test result, the test results determined to be lack (i.e., invalid) of the subject's familiarity is discarded without being stored in the storage device 4 as the training data. As a result, since only the accurately measured test results can be selected as the training data, it is possible to train the inference model which infers the inner surface condition with high accuracy. Supplementary description will be given of specific examples of the effect in this case. As a first example, when conducting a memory test and estimating (or training such a model) a comprehensive cognitive function (which refers to not only memory but also other cognitive functions including linguistic capability and IQ, etc.,) of the subject from test results determined to have the familiarity (i.e., to be regarded as valid), the noises (data having unfamiliarity) of input data are reduced by the use of only data having the familiarity according to the determination result in the present example embodiment. Accordingly, it is possible to perform more accurate estimation. As a second example, when conducting a computational capability test and estimating the attention function of the subject from the test result by rule-based approach or a learning model, it is possible to estimate the attention function of the subject more accurately by using only the computational capability test results determined to have familiarity according to the familiarity determination result in the present example embodiment. On the other hand, since it is said that there is a relation between computational ability and attention function, it is also possible to estimate the attention function by rule-based approach. Thus, it is possible to utilize the familiarity determination result in the present example embodiment even in the case of estimating and analogizing another similar ability from a certain ability.

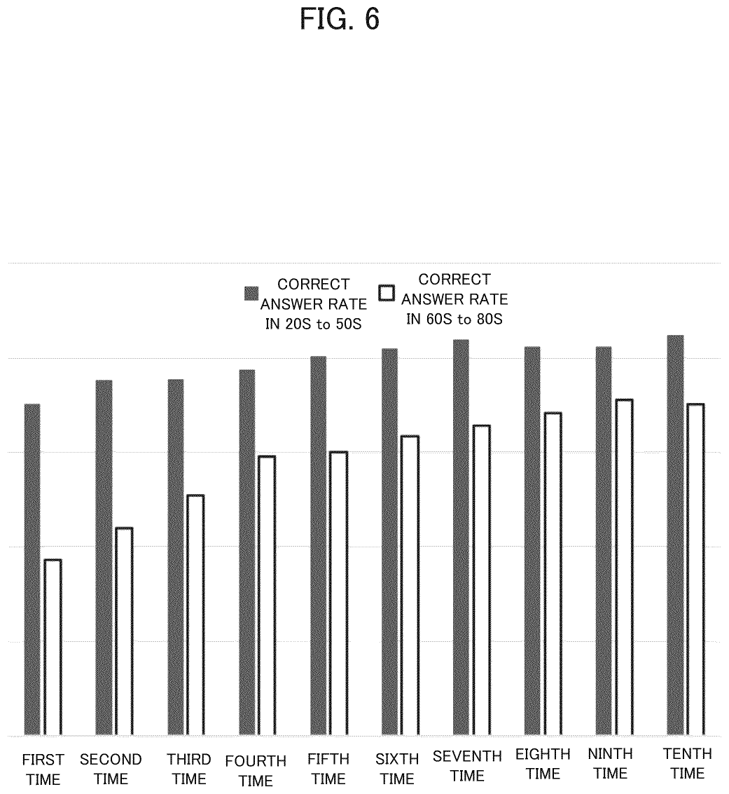

Here, the relation between the attributes and the required trial quantity will be supplementally described with reference to FIG. 6.

FIG. 6 shows the results of an experiment showing the average correct answer rate for a test conducted by subjects in their 20s to 50s and by subjects in their 60s to 80s. Here, we show the average correct answer rate for each age group when the test is undergone at first time to tenth time. All the tests undergone by the subjects fall under the same type, and the contents themselves are different at each time.

As shown in FIG. 6, the correct answer rate varies in each age group depending on the familiarity with the test. Here, regarding the correct answer rates for the subjects in their 20s to 50s, the variation from the correct answer rate at the first time to the correct answer rate at the second time is relatively large, and the subsequent variations are small. On the other hand, regarding the correct answer rates for the subjects in their 60s to 80s, the correct answer rates until the ninth time tend to rise. Accordingly, it is understood that the number of trials required to become familiar with the test differs depending on the age, which is an example of the subject's attributes. Taking the above into consideration, the information processing device 1 according to the present example embodiment estimates the required trial quantity based on the attribute information of the subject. Thus, it is possible to obtain an appropriate familiarity determination result according to the attribute(s) of the subject.

Here, for example, each component of the attribute data acquisition unit 15, the trial quantity estimation unit 16, the familiarity determination unit 17, the test processing unit 18, and the output control unit 19 described in FIG. 3 can be realized by the processor 11 executing a program. In addition, the necessary program may be recorded in any non-volatile storage medium and installed as necessary to realize the respective components. In addition, at least a part of these components is not limited to being realized by a software program and may be realized by any combination of hardware, firmware, and software. At least some of these components may also be implemented using user-programmable integrated circuitry, such as FPGA (Field-Programmable Gate Array) and microcontrollers. In this case, the integrated circuit may be used to realize a program for configuring each of the above-described components. Further, at least a part of the components may be configured by a ASSP (Application Specific Standard Produce), ASIC (Application Specific Integrated Circuit) and/or a quantum processor (quantum computer control chip). In this way, each component may be implemented by a variety of hardware. The above is true for other example embodiments to be described later. Further, each of these components may be realized by the collaboration of a plurality of computers, for example, using cloud computing technology.

(4) Model Learning

Next, a learning method of a trial quantity inference model will be described. Hereafter, as an example, a case where the information processing device 1 trains the trial quantity inference model will be described. However, a device other than the information processing device 1 may train the trial quantity inference model instead. Hereafter, a person who became a subject in the generation of training data is also referred to as “sample provider”. There may be plural sample providers and the sample providers may or may not include the subject in the inference stage.

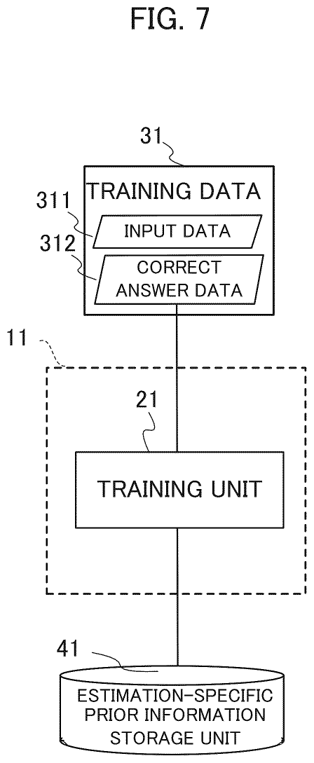

FIG. 7 is an example of functional block diagram of the processor 11 of the information processing device 1 relating to learning of the trial quantity inference model. Regarding learning of the trial quantity inference model, the processor 11 functionally includes a training unit 21. Further, the storage device 4 or the like stores the training data 31.

The training data 31 is training data to be used for learning of the trial quantity inference model and includes input data 311 and correct answer data 312. The input data 311 corresponds to attribute information of the tested sample providers, and the correct answer data 312 indicates the correct answer of the required trial quantity the trial quantity inference model should output for each record of the input data 311. For example, the correct answer data 312 indicates the required trial quantity of the sample provider for each record of the input data 311 that was identified based on the experimental results or the like as shown in FIG. 6.

The correct answer data 312 of a target test to be used for the learning of the trial quantity inference model may be generated from the correct answer data (or the corresponding experimental results) of another test based on the difficulty of the target test. For example, the correct answer data 312 of the target test to be used for the learning of the trial quantity inference model may be generated based on the correct answer data of another test that has the same or similar difficulty level as the target test.

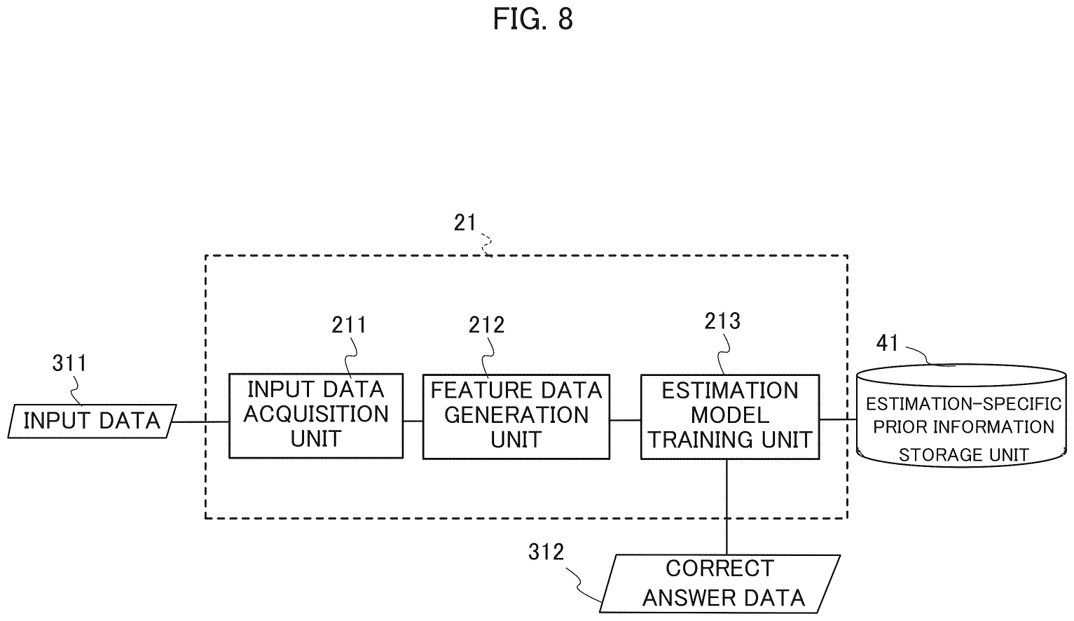

The training unit 21 trains the trial quantity inference model on the basis of the input data 311 and the correct answer data 312 and stores the parameters of the trial quantity inference model obtained through the training in the estimation-specific prior information storage unit 41. FIG. 8 is an example of a detailed functional block of the training unit 21. The training unit 21 functionally includes an input data acquisition unit 211, a feature data generation unit 212, and an estimation model training unit 213.

The input data acquisition unit 211 extracts from the training data 31 one record of the input data 311 to which the trial quantity inference model is applied. The feature data generation unit 212 generates the feature data conforming to the input format of the trial quantity inference model from the extracted record of the input data 311 acquired by the input data acquisition unit 211. The feature extraction process executed by the feature data generation unit 212 is the same algorithm as the feature extraction process executed by the feature data generation unit 61.

The estimation model training unit 213 updates the parameters of the trial quantity inference model such that the error (loss) between the required trial quantity to be outputted by the trial quantity inference model when the feature data is inputted to the trial quantity inference model based on the parameters stored in the estimation-specific prior information storage unit 41 and the correct answer indicated by the correct answer data 312 corresponding to the used record of the input data 311 is minimized. The algorithm for determining the parameters to minimize the loss may be any learning algorithm used in machine learning, such as the gradient descent method and the error back propagation method. The estimation-specific prior information storage unit 41 may store the initial parameters of the trial quantity inference model prior to the training of the trial quantity inference model. Then, the training unit 21 executes this process to all records of the input data 311 or until a predetermined learning end condition is satisfied.

(5) Processing Flow

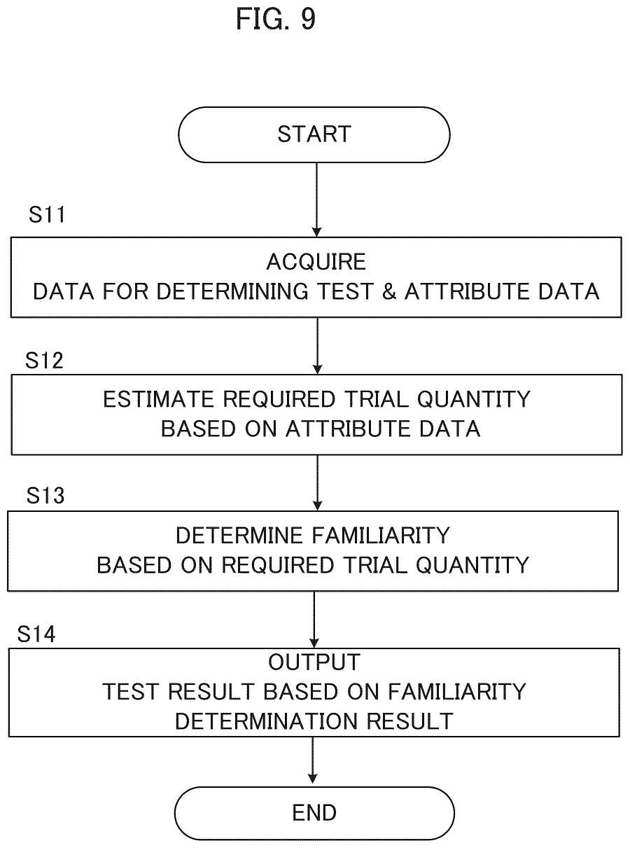

FIG. 9 is an example of a flowchart illustrating a processing procedure of the information processing device 1 when a test for a subject is conducted. The information processing device 1, for example, executes the processing of the flowchart shown in FIG. 9 when the test for the subject is conducted.

First, the information processing device 1 acquires test determination data and attribute data of a subject (step S11). In this instance, the information processing device 1 acquires the test determination data and the attribute data of the subject by receiving the input signal S1 from the input device 2 through the interface 13, for example. The information processing device 1 generates the test result based on the test determination data at any timing up to the process at step S14.

Then, the information processing device 1 estimates the required trial quantity based on the attribute data acquired at step S11 (step S12). In this case, the information processing device 1 may acquire the required trial quantity based on the trial quantity inference model configured by referring to the learned parameters stored in the estimation-specific prior information storage unit 41, or may acquire the required trial quantity based on the trial quantity determination table.

Next, the information processing device 1 determines whether or not the subject is familiar with the test based on the required trial quantity estimated at step S12 (step S13). In this case, the information processing device 1 generates the familiarity determination result based on the comparison result between the actual trial quantity that is the actual value of the number of trials or the trial duration in the current examination and the required trial quantity.

Next, the information processing device 1 outputs the test result or the like based on the familiarity determination result (step S14). In this case, for example, the information processing device 1 supplies the output signal S2 to the output device 3 so that the output device 3 performs a display or audio output relating to the test result and the validity of the test result based on the familiarity determination result. Thus, the information processing device 1 can suitably present, to the subject or his or her manager or the like, the validity of the test result based on the familiarity determination result together with the test result of the subject.

(6) Modifications

A description will be given of a preferred modifications to the example embodiment described above. The modifications may be applied to the above example embodiment in any combination.

(First Modification)

In addition to the attribute data, the information processing device 1 may estimate the required trial quantity based on the past test results of the subject.

In this case, for example, test results obtained through the past examinations periodically undergone by the subject is stored in the storage device 4 or the like. Then, the trial quantity estimation unit 16 inputs, to the trial quantity inference model, the attribute data which incorporates the past test results obtained in the examination (the preceding examination) that the subject has received just before the current examination, or the feature data thereof, and acquires the required trial quantity that the trial quantity inference model outputs. In this case, the trial quantity inference model is a model which learned the relation between the data based on the past test results and attribute data of the subject and the required trial quantity. In other words, the trial quantity inference model is a model which learned to output the required trial quantity of the subject when the combination of the attribute data and the past test results of the subject or the feature data of the combination are inputted thereto. Therefore, the input data of the training data 31 used for training the trial quantity inference model includes the past test results of the subject in addition to the attribute data of the subject.

Here, the above-described “past test results” may be one test result in the immediately preceding examination (for example, the test result of the first test in the immediately preceding examination), or may be time-series test results in the immediately preceding examination (for example, all or a predetermined number of test results in the immediately preceding examination).

If any test result of the past examination of the subject is not stored in the storage device 4 or the like, the trial quantity estimation unit 16 may determine the required trial quantity from the attribute data using the trial quantity determination table stored in the estimation-specific prior information storage unit 41.

Further, the trial quantity estimation unit 16 may use, as “past test results”, instead of the test results in the preceding examination, results of the test already conducted in the current examination. In this case, for example, the trial quantity estimation unit 16 uses the result of the test at the first time in the current examination as “the past test result” in the estimation processing of the required trial quantity at the second and subsequent tests in the current examination. In this case, in the estimation processing of the required trial quantity at the first test in the current examination, the trial quantity estimation unit 16 uses the trial quantity determination table to determine the required trial quantity.

As described above, the trial quantity estimation unit 16 determines the required trial quantity in consideration of the past test results of the subject thereby to accurately determine the required trial quantity of the subject.

(Second Modification)

If the subject has undergone a preceding examination including the same type of test as the test in the current examination within a predetermined period, the information processing device 1 may calculate the actual trial quantity to which the trial quantity of the test in the preceding examination is added.

For example, when the above-described predetermined period is one month and the trial quantity is the number of trials, the information processing device 1 determines whether or not the subject has undergone the examination including the same type of test as the test in the current examination within the past one month based on the history information of the test of the subject stored in the storage device 4. Then, in such a case where the information processing device 1 determines that the examination in which the test with the same type was conducted N times (N is an integer) had been conducted three weeks before the current examination, it determines the actual trial quantity at the first test of the current examination to be “N+1” which includes the number of test trials of the preceding examination. In this way, the information processing device 1 can generate the familiarity determination result in which the familiarity with the test based on the past examination is accurately considered. The information processing device 1 may set the weight which ranges from 0 to 1 for the trial quantity in the past examination so as to decrease the weight by which the trial quantity in the past examination is multiplied with increase in the length of the elapsed time after conducting the preceding examination.

According to this modification, it is possible to generate a familiarity determination result in which the familiarity with test based on a test trial result of a subject recently conducted is accurately taken into consideration.

### Second Example Embodiment

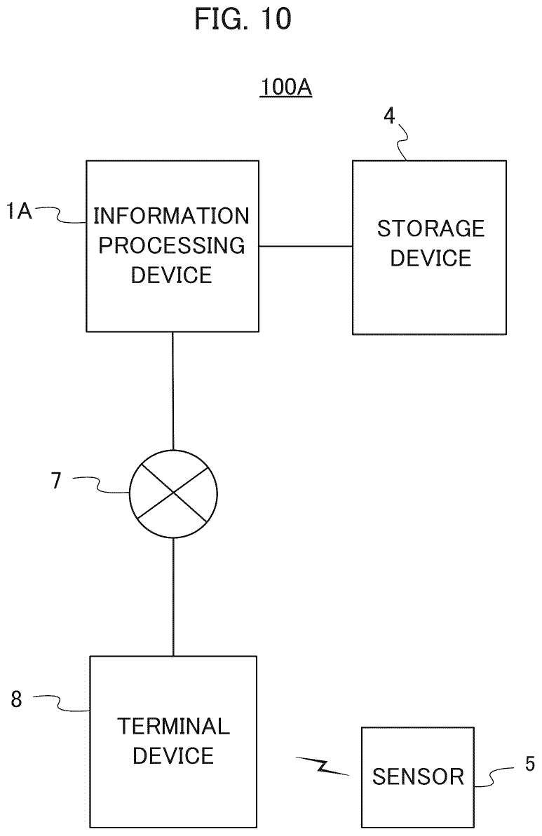

FIG. 10 shows a schematic configuration of a test determination 100A according to a second example embodiment. The test determination system 100A according to the second example embodiment is a server client model system, and the information processing device 1A that functions as a server device performs the processing executed by the information processing device 1 in the first example embodiment. Hereinafter, the same components as those in the first example embodiment are appropriately denoted by the same reference numerals, and a description thereof will be omitted.

The test-determining system 100A mainly includes an information processing device 1A that functions as a server, a storage device 4 that stores the same data as in the first example embodiment, and a terminal device 8 that functions as a client. The information processing device 1A and the terminal device 8 perform data communication via the network 7 with each other.

The terminal device 8 is a terminal having an input function, a display function, and a communication function, and functions as the input device 2 and the output device 3 shown in FIG. 1. The terminal device 8 may be, for example, a personal computer, a tablet-type terminal, a PDA (Personal Digital Assistant), or the like. The terminal device 8 transmits data such as an input signal based on user input and the biological signal outputted by one or more sensors (not shown) to the information processing device 1A.

The information processing device 1A has the same hardware configuration and function configuration as the information processing device 1, for example. Then, the information processing device 1A receives information, which the information processing device 1 illustrated in FIG. 1 acquired from the input device 2, from the terminal device 8 via the network 7, and generates a test result, a familiarity determination result, and the like based on the received information. The information processing device 1A transmits the generated test result and the output signal indicating the information regarding the familiarity determination result to the terminal device 8 through the network 7. Namely, in this case, the terminal device 8 functions as the output device 3 in the first example embodiment. Accordingly, the information processing device 1A suitably presents the information regarding the test result to the user of the terminal device 8.

### Third Example Embodiment

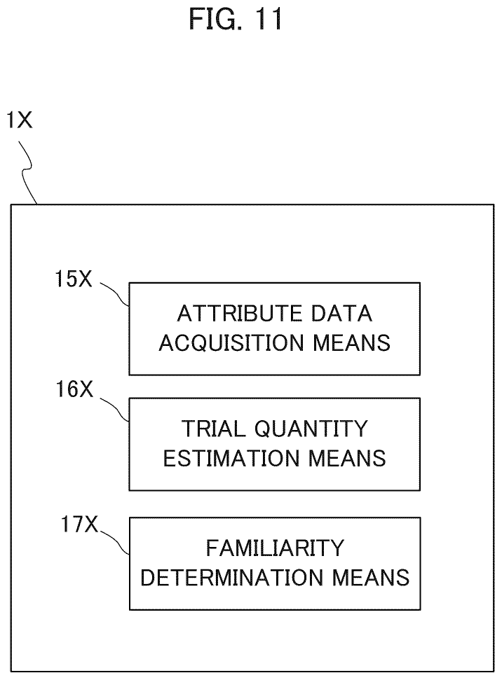

FIG. 11 is a block diagram of a determination device 1X in the third example embodiment. The determination device 1x mainly includes an attribute data acquisition means 15X, a trial quantity estimation means 16X, and a familiarity determination means 17X. The determination device 1X may be configured by a plurality of devices. Examples of the determination device 1x include the information processing device 1 in the first example embodiment (including modifications, the same applies hereinafter) and the information processing device 1A in the second example embodiment.

The attribute data acquisition means 15X is configured to acquire attribute data indicating an attribute of a subject. Examples of the attribute data acquisition unit 15X include the attribute data acquisition unit 15 in the first example embodiment and the second example embodiment.

The trial quantity estimation means 16X is configured to estimate a required trial quantity, which is a trial quantity to be required for the subject to become familiar with a test undergone by the subject, based on the attribute data. Examples of the trial quantity estimation means 16X include the trial quantity estimation unit 16 in the first example embodiment and the second example embodiment.

The familiarity determination means 17X is configured to determine whether or not the subject is familiar with the test, based on the required trial quantity. Examples of the familiarity determination means 17X include the familiarity determination unit 17 in the first example embodiment and the second example embodiment.

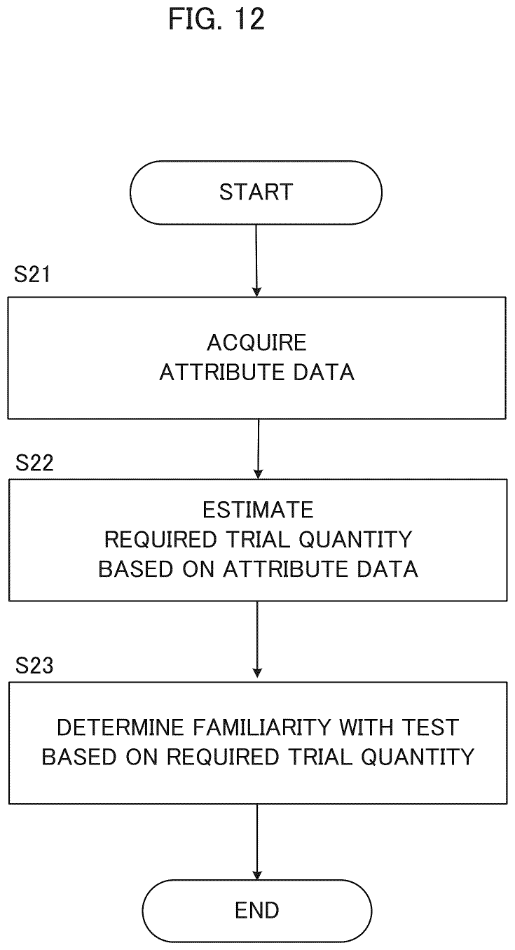

FIG. 12 is an example of the flowchart executed by the determination device 1X in the third example embodiment. The attribute data acquisition means 15X acquires attribute data indicating an attribute of a subject (step S21). The trial quantity estimation means 16X estimates a required trial quantity, which is a trial quantity to be required for the subject to become familiar with a test undergone by the subject, based on the attribute data (step S22). The familiarity determination means 17X determines whether or not the subject is familiar with the test, based on the required trial quantity (step S23).

According to the third example embodiment, the determination device 1X can accurately determine whether or not the subject has been familiar with the test according to the attribute of the subject.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

The whole or a part of the example embodiments (including modifications, the same shall apply hereinafter) described above can be described as, but not limited to, the following Supplementary Notes.

### Supplementary Note 1

A determination device comprising:
an attribute data acquisition means configured to acquire attribute data indicating an attribute of a subject;
a trial quantity estimation means configured to estimate a required trial quantity, which is a trial quantity to be required for the subject to become familiar with a test undergone by the subject, based on the attribute data; and
a familiarity determination means configured to determine whether or not the subject is familiar with the test, based on the required trial quantity.

[Supplementary Note 2]

The determination device according to Supplementary Note 1,
wherein the trial quantity estimation means is configured to estimate the required trial quantity based on the attribute data and an inference model, and
wherein the inference model is a model which learned a relation between
   data based on the attribute data and
   the required trial quantity.

### Supplementary Note 3

The determination device according to Supplementary Note 1,
wherein the trial quantity estimation means is configured to estimate the required trial quantity based on
   the attribute data,
   an inference model, and
   a test result of the test, and
wherein the inference model is a model which learned a relation between
   data based on the attribute data and the test result and
   the required trial quantity.

### Supplementary Note 4

The determination device according to Supplementary Note 3,
wherein the test result is time-series results of the test that the subject underwent in the past.

### Supplementary Note 5

The determination device according to Supplementary Note 1,
wherein the trial quantity estimation means is configured to estimate the required trial quantity from the attribute data, based on a table in which each of candidates for the attribute is associated with the required trial quantity corresponding to the each of the candidates.

### Supplementary Note 6

The determination device according to Supplementary Note 1, further comprising
an output control means configured to output a test result of the test based on a determination result of whether or not the subject is familiar with the test.

### Supplementary Note 7

The determination device according to Supplementary Note 6,
wherein the output control means is configured to determine that the test result of the test is invalid if the determination result indicates that the subject is not familiar with the test.

[Supplementary Note 8]

The determination device according to Supplementary Note 6,
wherein the output control means is configured to display or output, by audio, a determination result of validity of the test based on the determination result of whether or not the subject is familiar with the test.

[Supplementary Note 9]

A determination method executed by a computer, the determination method comprising:
acquiring attribute data indicating an attribute of a subject;
estimating a required trial quantity, which is a trial quantity to be required for the subject to become familiar with a test undergone by the subject, based on the attribute data; and
determining whether or not the subject is familiar with the test, based on the required trial quantity.

### Supplementary Note 10

A storage medium storing a program executed by a computer, the program causing the computer to:
acquire attribute data indicating an attribute of a subject;
estimate a required trial quantity, which is a trial quantity to be required for the subject to become familiar with a test undergone by the subject, based on the attribute data; and
determine whether or not the subject is familiar with the test, based on the required trial quantity.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. Each example embodiment can be appropriately combined with other example embodiments. All Patent and Non-Patent Literatures mentioned in this specification are incorporated by reference in its entirety.

### INDUSTRIAL APPLICABILITY

For example, it is used for services relating to management (including self-management) for identifying and sustaining the ability of the cognitive functions.

### DESCRIPTION OF REFERENCE NUMERALS

1, 1A Information processing device
1X Determination device
2 Input device
3 Output device
4 Storage device
8 Terminal device
100, 100A Test determination system

What is claimed is:

1. A test familiarity determination device in communication with client device, the test familiarity determination device comprising:
at least one memory configured to store instructions; and
at least one processor configured to execute the instructions to:
acquire attribute data indicating an attribute of a subject from an input device;
estimate, based on the attribute data, a required trial quantity of a test, wherein the required trial quantity is a quantity to be required for the subject to become familiar with the test undergone by the subject, and wherein the test is collectively conducted for multiple times as necessary until an accurate test result is obtained, and is a test of a cognitive function relating to at least one of categories of intelligence including at least one of language understanding, perceptual integration, working memory, and processing speed, an attention function, a frontal leaf function, language, memory, visual space cognition, and directed attention;
determine whether the subject is familiar with the test, based on the required trial quantity; and
output, to the client device, a test result and validity of the test result in case the test result is determined to be valid.

2. The test familiarity determination device according to claim 1,
wherein the at least one processor is further configured to execute the instructions to:
estimate the required trial quantity based on the attribute data and an inference model, and
wherein the inference model is a model which learned a relation between
data based on the attribute data and
the required trial quantity.

3. The test familiarity determination device according to claim 1,
wherein the at least one processor is further configured to execute the instructions to:
estimate the required trial quantity based on
the attribute data,
an inference model, and
the test result, and
wherein the inference model is a model which learned, by machine learning, a relation between
data based on the attribute data and the test result and
the required trial quantity.

4. The test familiarity determination device according to claim 3,
wherein the test result is time-series results of the test that the subject underwent in the past.

5. The test familiarity determination device according to claim 1,
wherein the at least one processor is further configured to execute the instructions to:
estimate the required trial quantity from the attribute data, based on a table in which each of candidates for the attribute is associated with the required trial quantity corresponding to the each of the candidates.

6. The test familiarity determination device according to claim 1,
wherein the at least one processor is further configured to execute the instructions to:
determine that the test result of the test is invalid if the determination result indicates that the subject is not familiar with the test.

7. The test familiar determination device according to claim 1,
wherein the at least one processor is further configured to execute the instructions to:
output, to the client device, advice information for a manager of the subject to perform a decision-making regarding whether to continue to conduct the test.

8. The test familiarity determination device according to claim 1,
wherein the least one processor is further configured to execute the instructions to:
display, to the client device, a determination result of the validity of the test based on the determination result of whether the subject is familiar with the test.

9. The test familiarity determination device according to claim 1,
wherein the least one processor is further configured to execute the instructions to:
output to the client device, by audio, a determination result of the validity of the test based on the determination result of whether the subject is familiar with the test.

10. The test familiar determination device according to claim 1,
wherein
the required trial quantity is a number of trials the subject has undergone the test in the one examination; and
the at least one processor is further configured to execute the instructions to:
estimate, based on the attribute data, the number of required trial for the subject to become familiar with the test; and
determine the subject is familiar with the test if a number of actual trail by the subject is more than the number of required trial.

11. A test familiarity determination method comprising:
acquiring attribute data indicating an attribute of a subject from an input device;
estimating, based on the attribute data, a required trial quantity of a test, wherein the required trial quantity is a quantity to be required for the subject to become familiar with the test undergone by the subject, and wherein the test is collectively conducted for multiple times as necessary until an accurate test result is obtained, and is a test of a cognitive function relating to at least one of categories of intelligence including at least one of language understanding, perceptual integration, working memory, and processing speed, an attention function, a frontal leaf function, language, memory, visual space cognition, and directed attention;
determining whether the subject is familiar with the test, based on the required trial quantity; and
output a test result and validity of the test result in case the test result is determined to be valid to an output device.

12. A non-transitory computer readable storage medium storing a program executed by a computer, the program causing the computer to:
acquire attribute data indicating an attribute of a subject from an input device;
estimate, based on the attribute data, a required trial quantity of a test, wherein the required trial quantity is a quantity to be required for the subject to become familiar with the test undergone by the subject, and wherein the test is collectively conducted for multiple times as necessary until an accurate test result is obtained, and is a test of a cognitive function relating to at least one of categories of intelligence including at least one of language understanding, perceptual integration, working memory, and processing speed, an attention function, a frontal leaf function, language, memory, visual space cognition, and directed attention;
determine whether the subject is familiar with the test, based on the required trial quantity; and
output a test result and validity of the test result in case the test result is determined to be valid to an output device.
